(19) United States
(12) Patent Application Publication
(10) Pub. No.: US 2002/0043002 A1
(43) Pub. Date: Apr. 18, 2002

(54) Pivot shaft device for adjusting relative angle between two objects

(76) Inventor: Chia Yu Liao, Taipei (TW)

Correspondence Address: Liao, Chia Yu, 235 Chung-Ho, Box 8-24, Taipei, TW

(21) Appl. No.: 09/963,708

(22) Filed: Sep. 27, 2001

(30) Foreign Application Priority Data
Oct. 13, 2000 (TW) 89217776

(51) Int. Cl. B43L 7/10

(52) U.S. Cl. 33/495

(57) ABSTRACT

A pivot shaft device installed between an object and a body for adjusting a relative angle therebetween is disclosed. The pivot shaft device comprises an axial shaft, an axial sleeve and at least one retaining element. Each retaining element has a plurality of friction arms and at least one positioning portion. The plurality of friction arms are arranged along the axial direction of the axial sleeve and are parallel to each other. The positioning portion is integrally connected to each of the ends of the friction arms. When the axial shaft inserts into the axial sleeve installed with the retaining element, as the object rotates with respect to the body, a steady torsional force is generated by the interaction of the friction arms and the first axial portion.

### FIELD OF THE INVENTION

The present invention relates to a pivot shaft device, and particularly to a pivot shaft device installed between an object and a body for adjusting a relative angle therebetween.

### BACKGROUND OF THE INVENTION

A pivot shaft device is installed to an object so that the orientation of the object is adjustable with respect to a body mounted the object. To cause the object to position at a selected position, a steady torsional force is generated between the object and the body by a friction force therebetween. Thereby, the object can be positioned at a selected angle. For example, a keyboard and a liquid crystal display of a notebook computer are installed with the pivot shaft device for controlling the angle therebetween.

In U.S. Pat. No. 5,697,125, a pivot shaft device is disclosed, wherein the pivot shaft device can generate a steady torsional force by a friction force. The pivot shaft device has a rotatable post, a plurality of annular thin plate elements capable of being inserted by the post and thus providing a steady torsional force, and a sleeve for fixing the annular thin plate elements. Two ends of the post are utilized to install an object (for example, liquid crystal screen of a notebook computer). The sleeve is installed in a body (for example, a keyboard of the notebook computer). If the angle between the screen and the keyboard is necessary to be adjusted, the post can be positioned in a selected angle by the friction force between the outer surface of the post and the inner surfaces of the annular thin plate elements and the trosional force between the annular thin plate elements and the sleeve. Although above prior art provides a steady torsional force, to install the annular thin plate elements is complex and difficult so that the cost and time of assembly are increased.

### SUMMARY OF THE INVENTION

Accordingly, the primary object of the present invention is to provide a pivot shaft device installed between an object and a body for adjusting a relative angle therebetween, wherein as the object rotates with respect to the body installed with the object, a steady torsional force is generated by the present invention. The object can be steadily positioned in a selected angle.

Another object of the present invention is to provide a pivot shaft device installed between an object and a body for adjusting a relative angle therebetween, wherein the pivot shaft device can be assembled easily so that the cost and assembly time can be saved.

To achieve above objects, the present invention provides a pivot shaft device installed between an object and a body for adjusting a relative angle therebetween. The pivot shaft device comprises an axial shaft, an axial sleeve and at least one retaining element. Each retaining element has a plurality of friction arms and at least one positioning portion. The plurality of friction arms are arranged along the axial direction of the axial sleeve and are parallel to each other. The positioning portion is integrally connected to each of the ends of the friction arms. By the engagement of the positioning portions and the positioning grooves in the axial sleeve, the retaining elements can be rapidly and easily assembled to the axial sleeve. When the axial shaft inserts into the axial sleeve installed with the retaining elements, as the object rotates with respect to the body, a steady torsional force is generated by the interaction of the friction arms and the first axial portion.

The various objects and advantages of the present invention will be more readily understood from the following detailed description when read in conjunction with the appended drawing.

### BRIEF DESCRIPTION OF THE DRAWINGS

FIG. 1 is an exploded perspective view of the pivot shaft device of the present invention.

FIG. 2 is a schematic perspective view of the retaining elements of the pivot shaft device in the present invention.

FIG. 3 is an assembled schematic view of the pivot shaft device of the present invention.

### DETAILED DESCRIPTION OF THE PREFERRED EMBODIMENTS

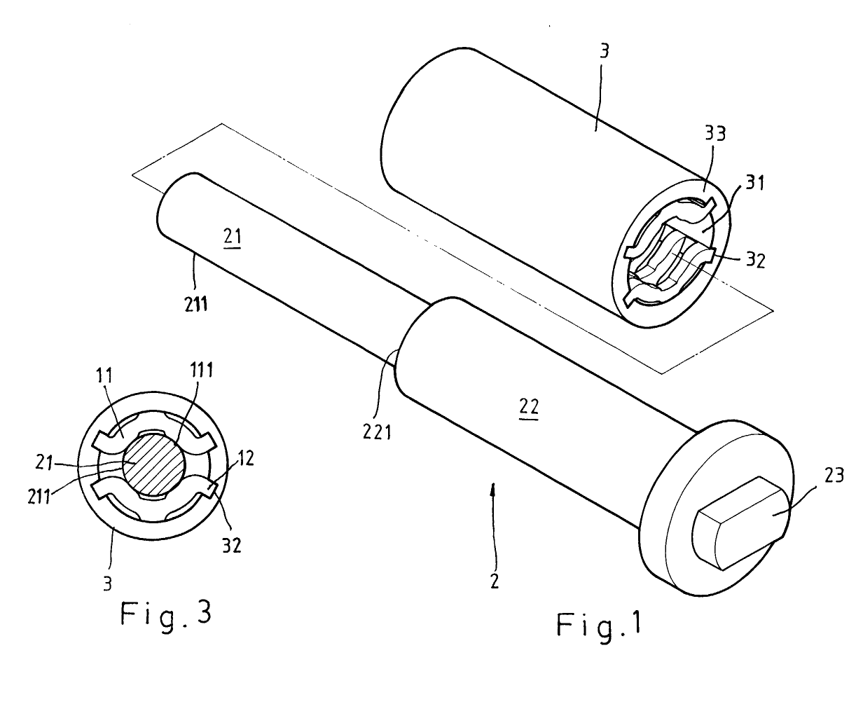

Referring to FIG. 1, the exploded perspective view of the preferred embodiment about the pivot shaft device of the present invention is illustrated. The pivot shaft device of the present invention includes an axial shaft 2, at least one retaining element 1 for providing a steady torsional force, and an axial sleeve 3 for fixing the retaining elements 1. The axial shaft 2 may pass through the retaining elements 1. In this embodiment, there are two retaining elements 1. One end of the axial shaft 2 is installed with a third axial portion 23 for being assembled with an object (not shown, for example, the liquid crystal display of a notebook computer). Another end of the axial shaft 2 is formed with a first axial portion 21 and a second axial portion 22. The second axial portion 22 is located between the first axial portion 21 and the third axial portion 23.

The axial sleeve 3 is a hollow structure and may be installed to a body (not shown, for example, a keyboard of a notebook computer). The inner diameter of the axial sleeve 3 is larger than the outer diameter of the first axial portion 21 and smaller than the outer diameter of the second axial portion 22. Thereby, the first axial portion 21 can be inserted into the axial sleeve 3, and further the second surface 221 of the second axial portion 22 resists against the first surface 33 of the axial sleeve 3 so that the axial sleeve 3 is positioned. The inner surface 31 of the axial sleeve 3 is formed with a plurality of positioning grooves 32 which are extended axially.

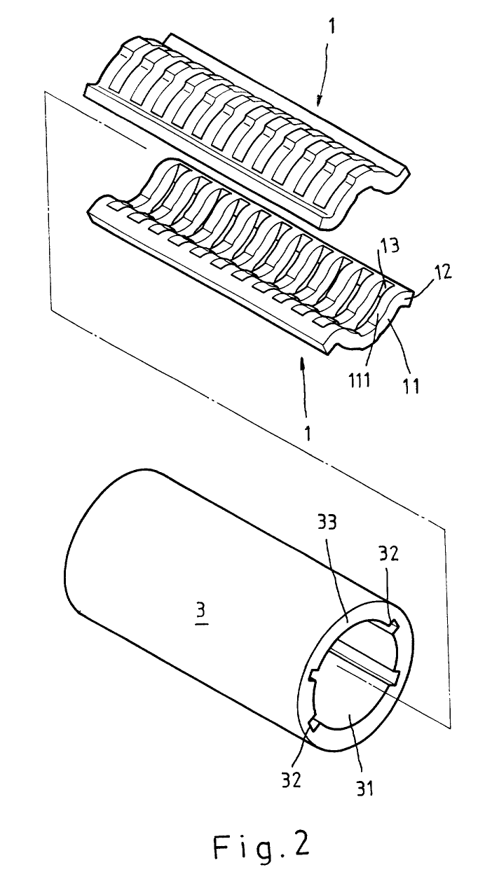

Referring to FIG. 2, the retaining element 1 has a plurality of friction arms 11 which have shapes like an arc and two positioning portions 12. The two positioning portions 12 are connected to the two ends of the plurality of friction arms 11 so that the retaining element 1 is formed as an integral body. The friction arms 11 are parallel to each other along the axial direction of the axial sleeve 3. Each two adjacent friction arms 11 are retained with a proper gap 13 so that the friction arms 11 of the retaining element 1 are adjustable to retain a steady and proper friction areas. The concave arc surface of each friction arm 11 is defined as a friction surface 111.

Referring to FIG. 3, in assembly, the positioning portions 12 of the retaining element 1 slide into the respective positioning grooves 32 of the axial sleeve 3.

Then, the first axial portion 21 of the axial shaft 2 passes through the axial sleeve 3 of the retaining element 1. Then outer surface 211 of the first axial portion 21 is in contact with the friction surfaces 111 of the friction arms 11 of the retaining element 1. When an object (not shown) installed with the axial shaft 2 rotates, by the friction forces between the friction surfaces 111 of the friction arms 11 of the retaining element 1 and the outer surface 211 of the first axial portion 21, a proper torsional force is retained. Therefore, the object is rotatable with respect to the body (not shown) installed with the axial sleeve 3 and is then positioned to a selected angle.

Moreover, to adjust the number of the friction arms 11 will induce a change of the torsional force.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A pivot shaft device installed between an object and a body for adjusting a relative angle therebetween; comprising:
an axial shaft having one end is installed with a third axial portion for being assembled with the object so as to drive the object to rotate, and another end of the axial shaft being formed with a first axial portion;
an axial sleeve being a hollow structure and being installed to the body; an inner diameter of the axial sleeve being larger than an outer diameter of the first axial portion; thereby, the first axial portion being capable of inserting into the axial sleeve, and an inner surface of the axial sleeve being formed with at least one positioning grooves; and
two retaining elements, one being matched to the other;
wherein each retaining element has a plurality of friction arms which are arranged along the axial sleeve and extends axially; a gap is retained between each two adjacent friction arms; at least one positioning portion serves to connect the plurality of friction arms so that each retaining element is formed as an integral body; each friction arm has a friction surface; the positioning portion is engaged to one of the positioning groove of the axial sleeve; thereby, the retaining element is assembled in the axial sleeve with each friction surface of the friction arm facing a center of the axial sleeve; as the object rotates with respect to the body, a steady torsional force is generated by the interaction of the friction surfaces of the friction arms and a surface of the first axial portion.

2. The pivot shaft device as claimed in claim 1, wherein each friction arm has a shape like an arc, and each positioning portion is positioned axially and connect one end of each friction arm of one retaining element.

3. The pivot shaft device as claimed in claim 2, wherein two ends of the plurality of friction arms are connected to respective positioning portions, and an inner surface of the axial sleeve is installed with respective positioning grooves.

4. The pivot shaft device as claimed in claim 3, wherein the plurality of friction arms are parallel to each other.

5. The pivot shaft device as claimed in claim 4, wherein the friction surface of each friction arm is at a concave portion of the arc, and the first axial portion of the axial shaft passes through the concave positioning portions of the plurality of friction arms; and an outer surface of the axial shaft is in contact with the friction surfaces.

6. The pivot shaft device as claimed in claim 5, wherein a second axial portion is installed between the first axial portion and the third axial portion; an outer diameter of the second axial portion is larger than an inner diameter of the axial sleeve; thereby, when the axial sleeve of the retaining element is inserted by the first axial portion of the axial shaft, the second axial portion resists against the axial sleeve.
